(19) United States
(12) Patent Application Publication
(10) Pub. No.: US 2017/0010673 A1
(43) Pub. Date: Jan. 12, 2017

(54) GESTURE BASED SHARING OF USER INTERFACE PORTION

(71) Applicant: Microsoft Technology Licensing, LLC, Redmond, WA (US)

(72) Inventors: Vijay Mital, Kirkland, WA (US); Henry Hun-Li Reid Pan, Sammamish, WA (US); Sandeep Suresh, Bellevue, WA (US); Bao Quoc Nguyen, Bellevue, WA (US); Fahimeh Raja, Kirkland, WA (US)

(21) Appl. No.: 14/794,752

(22) Filed: Jul. 8, 2015

(51) Int. Cl. G06F 3/01; G06F 3/0484

(52) U.S. Cl. CPC G06F 3/017; G06F 3/04842

(57) ABSTRACT

Gesture recognition and sharing technology that allows a user to gesture to share portions of a user interface. Upon recognizing when a portion selection gesture has been entered on a display, an associated portion of the user interface is identified based on spatial relation of the portion selection gesture. In response, the system causes the associated portion of the user interface to be shared for display on a remote display, perhaps by even sharing the portion of the application that generated the user interface portion. The portion selection gesture may be a position gesture that is centered on the portion to be displayed. The portion selection gesture may be a negative gesture that centers over a portion of the user interface not to be shared. By appropriate combination of position and negative gestures, fine-grained and efficient definition of the set of shared user interface element(s) may be made.

### BACKGROUND

Computing technology has revolutionized the way we work, play, and communicate. Computing functional is obtained by a device or system executing software or firmware. Often, an important tool to allow users to influence the execution of software is via a user interface displayed on a display. The user interface may itself be the ultimate end point of the software.

In collaborative environments, user interfaces are often shared between users. Also, in remote access environments, a user interface of one display may be remotely accessed from another computing system. Often, it is the entire display that is shared. Examples of collaborative environments and technologies include electronic whiteboarding, collaborative authoring, tracking/revision marking, and so forth.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to gesture recognition technology that allows a user to use gestures to share portions of a user interface (perhaps even by sharing the portions of the application that generate the user interface portion). A computing system, upon recognizing when a portion selection gesture has been entered on a display, associates the portion selection gesture with an associated portion of a user interface displayed on the display based on spatial relation of the portion selection gesture with the associated portion. In other words, the system estimates which user interface elements the user intended to select with the gesture. In response, the system causes the associated portion of the user interface to be shared for display on a remote display. In some embodiments, there may also be a target selection input received from the user that allows the system to identify which machines and/or users the selected user interface portion is to be shared with.

The portion selection gesture may be a positive gesture that is centered on the portion to be shared. Alternatively or in addition, the portion selection gesture may be a negative gesture (e.g., a redaction gesture) that centers over a portion of the user interface not to be shared. A compound selection gesture may include any number (zero or more) of positive gestures and any number (zero or more) of negative gestures to allow efficient entry of even complex selections of user interface elements.

By appropriate combination of position and/or negative gestures, fine-grained and efficient definition of the set of shared user interface element(s) may be made, and thus careful selection of shared user interface elements is enabled. This increases efficiency associated with sharing, and increases the user control over the sharing process.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 symbolically illustrates a computing system in which some embodiments described herein may be employed, and which includes a display on which a user interface may be rendered;

FIG. 2 symbolically illustrates a computer architecture for rendering on a display, recognizing gestures entered on that display, and controlling the rendering and sharing of user interface elements;

FIG. 3 illustrates a flowchart of a method for sharing a portion of a user interface (such as a set of one or more distinct user interface elements) with another display in accordance with the principles described herein;

FIG. 4A illustrates a specific example user interface in which there are several possibilities shown for the user to enter a positive portion selection gesture in the form of a substantial circling gesture;

FIG. 4B illustrates a further specific example use interface in which in addition to performing a positive portion selection gesture (in the form of a substantial circling of the selected portion), the user also entered a negative portion selection gesture (in the form of a crossing out gesture);

FIG. 4C illustrates a further specific example user interface, which is similar to that of FIG. 4B, except that the user further selects a target selection actuator for selected a target machine and/or user, and sharing the selected user interface portion(s) with that machine and/or user;

FIG. 5A illustrates an application instance that is preparing to be split to allow the associated user interface portion to be shared, the application instance having various related portions;

FIG. 5B illustrates an application instance that is split from the application instance of FIG. 5A;

FIG. 6 illustrates a flowchart of a method for formulating a split application;

FIGS. 7A through 7D illustrates various possible configurations for the split application instance of FIG. 5B; and

FIG. 8 illustrates an architecture in which a larger application instance that is assigned to one machine securely interfaces with a portion application instance that is assigned to a second machine via a proxy service;

### DETAILED DESCRIPTION

At least some embodiments described herein relate to gesture recognition technology that allows a user to use gestures to share portions of a user interface (perhaps even by sharing the portions of the application that generate the user interface portion). A computing system, upon recognizing when a portion selection gesture has been entered on a display, associates the portion selection gesture with an associated portion of a user interface displayed on the display based on spatial relation of the portion selection gesture with the associated portion. In other words, the system estimates which user interface elements the user intended to select with the gesture. In response, the system causes the associated portion of the user interface to be shared for display on a remote display. In some embodiments, there may also be a target selection input received from the user that allows the system to identify which machines and/or users the selected user interface portion is to be shared with.

The portion selection gesture may be a positive gesture that is centered on the portion to be shared. Alternatively or in addition, the portion selection gesture may be a negative gesture (e.g., a redaction gesture) that centers over a portion of the user interface not to be shared. A compound selection gesture may include any number (zero or more) of positive gestures and any number (zero or more) of negative gestures to allow efficient entry of even complex selections of user interface elements.

By appropriate combination of position and/or negative gestures, fine-grained and efficient definition of the set of shared user interface element(s) may be made, and thus careful selection of shared user interface elements is enabled. This increases efficiency associated with sharing, and increases the user control over the sharing process.

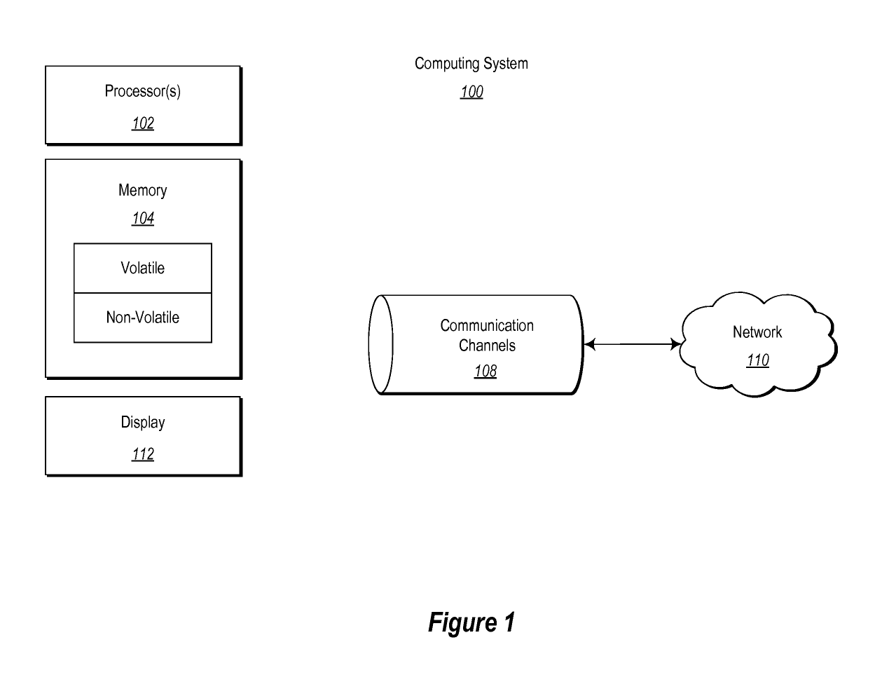

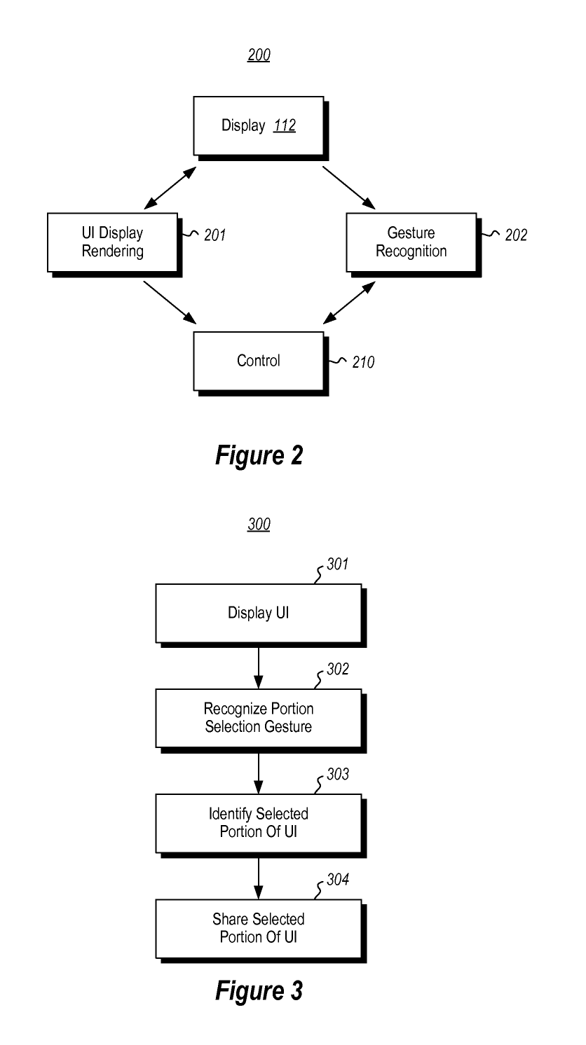

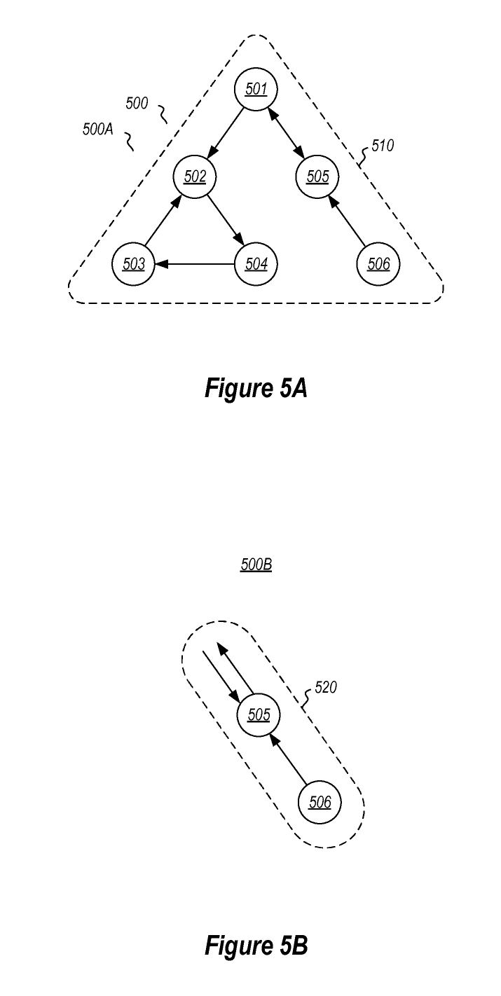

As the embodiments described herein may be implemented on a computing system, a computing system will first be described with respect to FIG. 1. Then, the principles of sharing a user interface portion (e.g., distinct user interface elements) will be described with respect to FIGS. 2 through 4C. Finally, the sharing of user interface elements by actually sharing the application portion itself will be described with respect to FIGS. 5A through 8.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110. The computing system 100 also includes a display 112 that may, for instance, display a user interface.

Embodiments described herein may comprise or utilize a special purpose or general purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries or even instructions that undergo some translation (such as compilation) before direct execution by the processors, such as intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 symbolically illustrates a computing architecture 200 for rendering on a display and recognizing gestures entered on that display. The architecture includes a user interface rendering component 201 that displays user interface elements on a display (e.g., display 112) of the computing system (e.g., computing system 100). The architecture 200 also includes a gesture recognition component 202 that recognizes gestures entered by a user on the display 112 with respect to the user interface. A control component 210 instructs the rendering component 201 on what to render, and responds to the gesture recognition component 202 recognizing a gesture by taking appropriate action (such as sharing the selected portion of the user interface). The control component 210 may be implemented on the same device as the display 112, may be connected to the device that includes the display 112 over a network (e.g., network 110), or a combination of the above. In one embodiment, for instance, the control component 210 may be implemented in a cloud computing environment.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

FIG. 3 illustrates a flowchart of a method 300 for sharing a portion of a user interface with another display in accordance with the principles described herein. The method 300 will be described with respect to the architecture 200 of FIG. 2. A user interface is rendered on a display (act 301). For instance, the user interface rendering component 201 of FIG. 2 may render a user interface on a display. That user interface may include any number of user interface elements, and having any arbitrary layout.

The method 300 also includes recognizing when portion selection gestures have been entered on the display (act 302). For instance, in FIG. 2, the gesture recognition component 202 recognizes when a user has entered a portion selection gesture on the display 112.

In response, the portion selection gesture is associated with the selection of a corresponding portion of the user interface displayed on the display (act 303). For instance, the logic component 210 and/or the gesture recognition component 202 estimates a set of one or more user interface elements that the user intends to select based on the portion selection gesture. The portion selection gesture may be a positive (inclusion) gesture, in which case the selected portion is spatially related to the selected portion and is centered on the user interface element(s) to be selected. The portion selection gesture may alternatively be a negative (exclusion or redaction) gesture, in which case the selected portion is to be excluded from the selected portion.

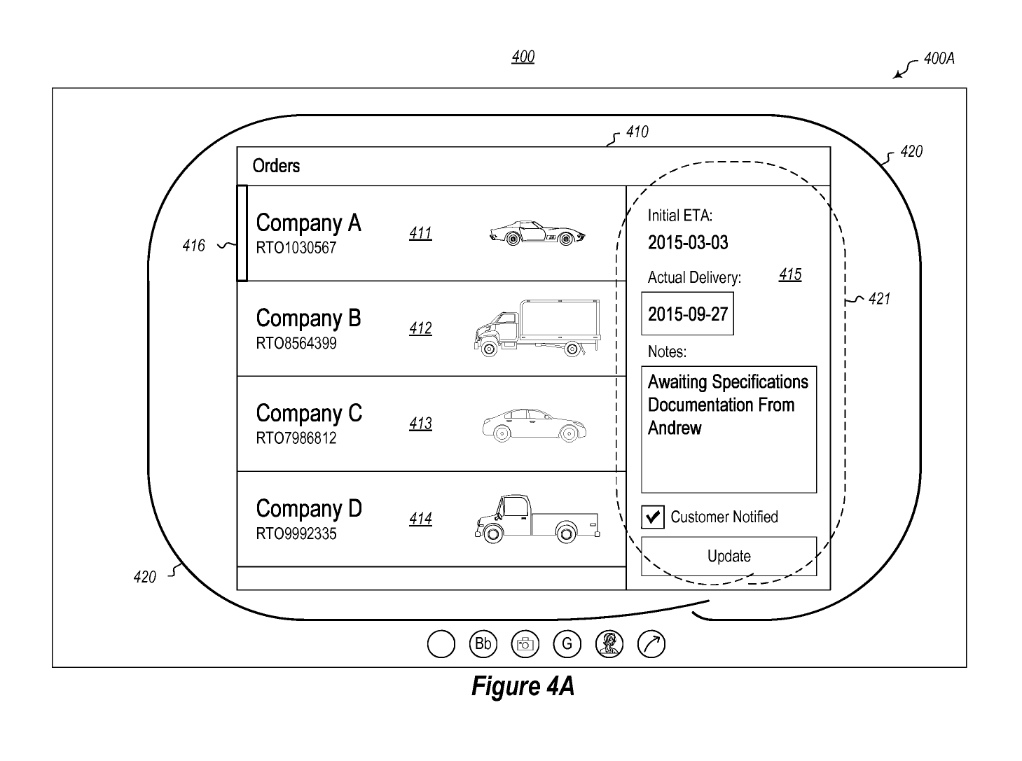

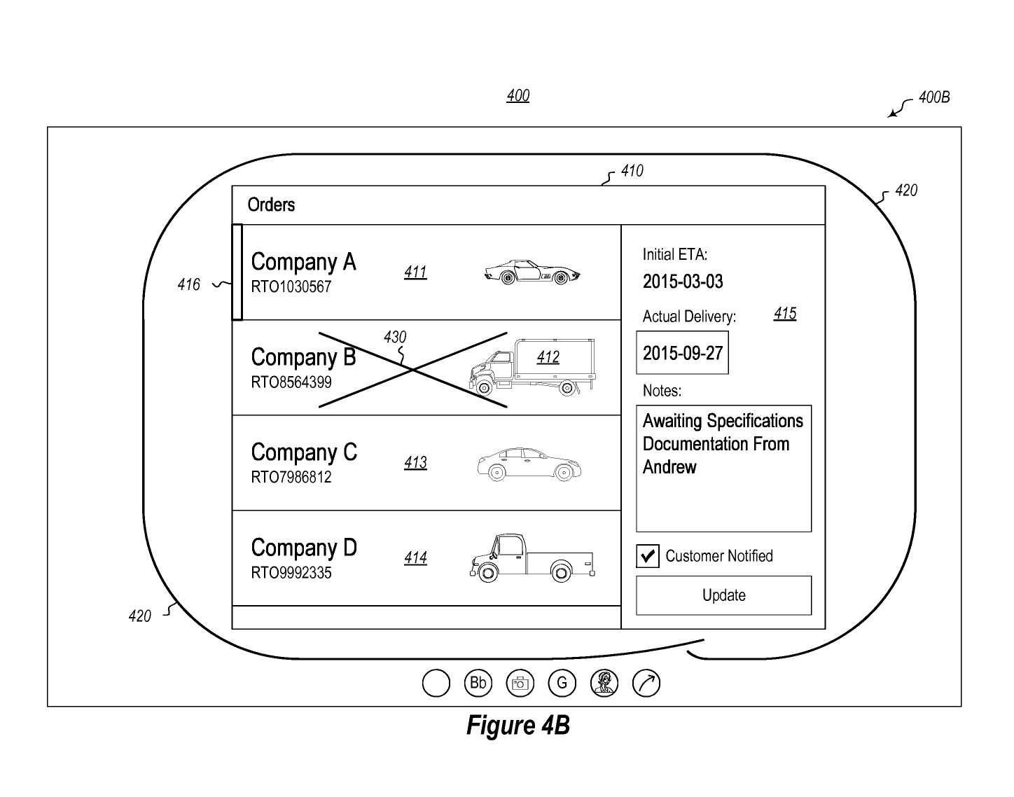

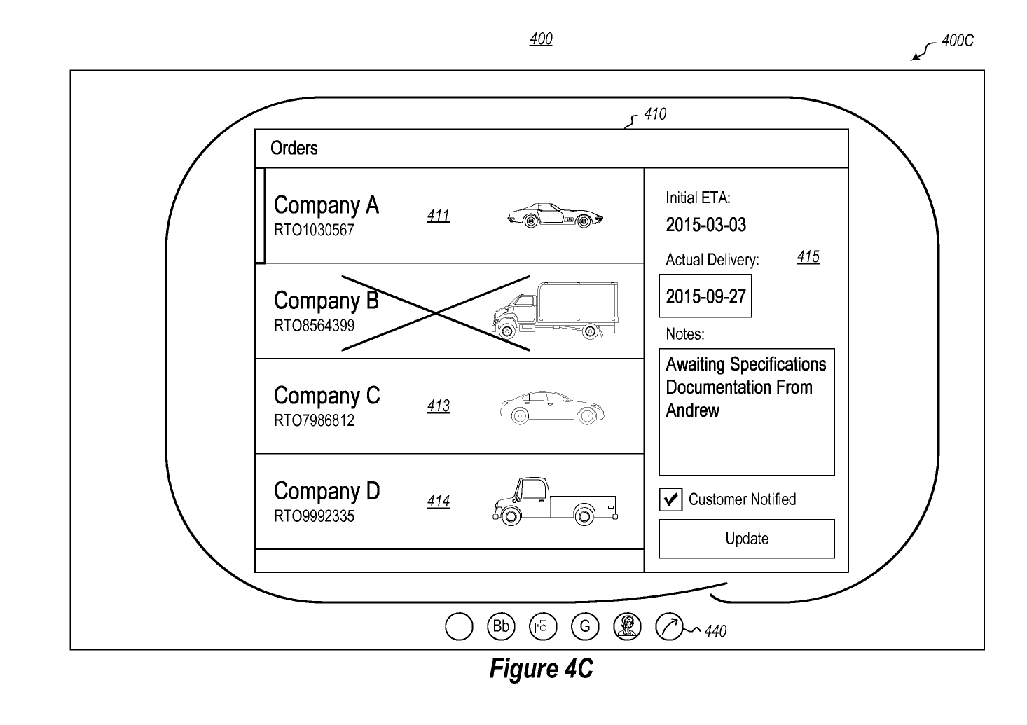

The selected user interface portion is then shared (act 304) with another device. For instance, the control component 210 may cause the associated portion of the user interface to be made available to a remote display that is remote from the original display 112. In some cases, the sharing of the user interface portion (act 304) occurs not just by sharing the user interface portion itself, but by sharing a portion of the application that functions to generate that user interface portion with a remote computing system associated with the remote display. This will be described further below with respect to FIGS. 5A through 8. But first, a specific user interface example will be provided with respect to FIGS. 4A through 4C.

FIG. 4A illustrates a specific example user interface 400A in which there are several possibilities for the user to enter a positive portion selection gesture in the form of a substantial circling gesture. As one example, the user enters a circling or encompassing gesture. For instance, the user might enter positive circling gesture 420 in order to select user interface element 410, which includes all of user interface elements 411 through 415. Note that user interface element 411 is actuated (as represented by selection visualization 416) to activate a details user interface element 415. Alternatively, the user might enter a smaller positive circling gesture 421 in order to select only user interface element 415.

In one embodiment, some user interface elements are shareable, and some are not. In that case, perhaps even if a user interface that is circled is not entirely sharable, the portion of the user interface that is circled and shareable may still be selected. For instance, if the entire user interface element 410 was not shareable, but the portion 415 was, then perhaps positive circling gesture 420 might cause only user interface element 415 to be selected.

The circling or encompassing gesture recognition may have a considerable degree of flexibility. As an example, the gesture might indicate that any user interface that is mostly (or with a certain percentage of area—such as 50 percent, 70 percent, 90 percent or the like) within the gesture is considered to have been selected. If the gesture does not represent a complete circling, then perhaps the two endpoints represented the incomplete ends are artificially joined in memory to determine whether enough of the user interface element is within bounds of the gesture to be considered selected.

FIG. 4B illustrates a further specific example use interface 400B in which in addition to performing a substantial circling gesture, the user also entered a negative portion selection gesture in the form of a crossing out gesture. In FIG. 4B, the negative portion selection gesture takes the form of a crossing-out gesture 430 occurring over user interface portion 412. A user interface element may be considered to be crossed out (i.e., redacted or excluded) from selection if the intersection of the two lines of the crossing out occurs over a particular user interface element. Again, there may be flexibility in how this gesture may be defined to prevent accidental redaction. For instance, the intersection might be required not only to be over the user interface element, but well within the user interface element with a certain margin.

Accordingly, as represented by FIG. 4B, a compound portion selection gesture is possible including the positive portion selection gesture 420 (e.g., selecting user interface portions 411 through 415) as well as the negative portion selection gesture 430 (e.g., excluding user interface portion 412). Thus, the compound portion selection gesture would be recognized as selecting only portions 411, 413, 414 and 415. The compound portion selection gesture may be even more complex and may include any combination of zero or more positive portion selection gestures with any zero or more negative portion selection gestures. This allows for an efficient way for a user to exercising intuitive and efficient control over which user interface elements are selected in a highly complex and granular way.

FIG. 4C illustrates a further specific example user interface 400C, which is similar to the user interface 400B that of FIG. 4B, except that the user further selects a target selection actuator 440 for sharing the selected user interface portion(s) with another device. Upon selecting the target selection actuator, the sharing of the selected user interface elements actually occurs. Thus, the user may share portions of a user interface with others, and exercise a high degree of control over which portions are shared.

In one embodiment, rather that sharing just the user interface portion with the remote display, the portion of the application that generates the user interface portion is shared with the remote computing system associated with the remote display. The remote computing system may then run the application portion to result in the user interface portion appearing on its display. FIGS. 5A through 8 illustrate how this application sharing may be accomplished.

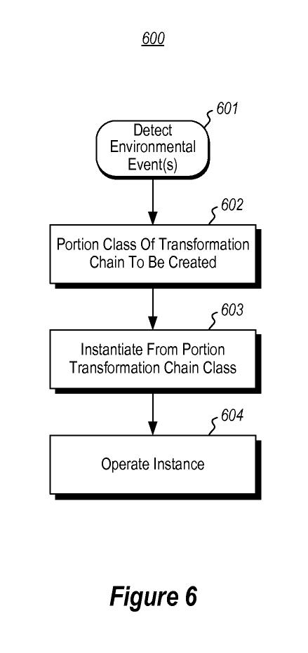

FIG. 5A illustrates an example application 500 in a state 500A in which it is about to be split for sharing. FIG. 6 illustrates a flowchart of a method 600 for formulating a split application. As the method 600 may be performed in the context of the example applications 500A and 500B of FIGS. 5A and 5B, respectively, the method 600 of FIG. 6 will be described with frequent reference to the example applications 500A and 500B.

As illustrated in FIG. 5A, the example application 500A includes six nodes 501 through 506. Each of the nodes may have zero or more input endpoints and zero or more output endpoints. However, to keep the diagram cleaner, the endpoints are not illustrated for the example application 500A of FIG. 5A. Likewise, the endpoints are not illustrated for the example application 500B in FIG. 5B.

In the initial state 500A of FIG. 5A, a particular machine and/or user is credentialed to provide input to and receive output from endpoints of application 500A. The scope of this credential is represented by the dashed lined boundary 510.

Now suppose that the application 500A is to be split. That is, suppose that the first user provides interaction or input suggesting that an application instance representing a portion of the larger application instance 500A is to be created for purposes of, at least temporarily, sharing the split application instance with a second machine and/or user. Such interaction might include the gestures described above. By so sharing, the associated user interface portion generated by the split application instances is also shared.

In any case, interaction and/or environmental event(s) are detected that are representative of splitting an instance of a smaller class off of the larger application class (act 601), thereby initiating the method 600 of FIG. 6. Based on the detected environment event(s) (e.g., the gestures described above), the system determines that a portion application class is to be created (act 602) that represents a portion of the larger application class. For instance, referring to FIG. 5A, suppose that a portion application class is to be created that is represented only by nodes 505 and 506. In response, an instance of the portion application class is instantiated (act 603) and operated (act 604). For instance, the second machine may be instructed (by the first machine) to interact with the endpoints of the instantiated portion application class. The instantiated portion application class may be sent to the second machine.

FIG. 5B represents the resulting portion application instance 500B that includes just the node 505 and the node 506. A dotted lined border 520 is illustrated to represent that a particular machine and/or user (e.g., the second machine and/or user) may have credentials to interface with some or all of the endpoints of the nodes 505 and 506. In one embodiment, the splitting is not made for purposes of delegation, and the first machine and/or user retains credentials to interface with the endpoints of nodes 505 and 506 in the new portion application 500B. However, a very useful scenario is that the first machine and/or user has delegated privileges to the second machine and/or user to interface with at least some endpoints of the nodes 505 and 506 of the portion application 500B.

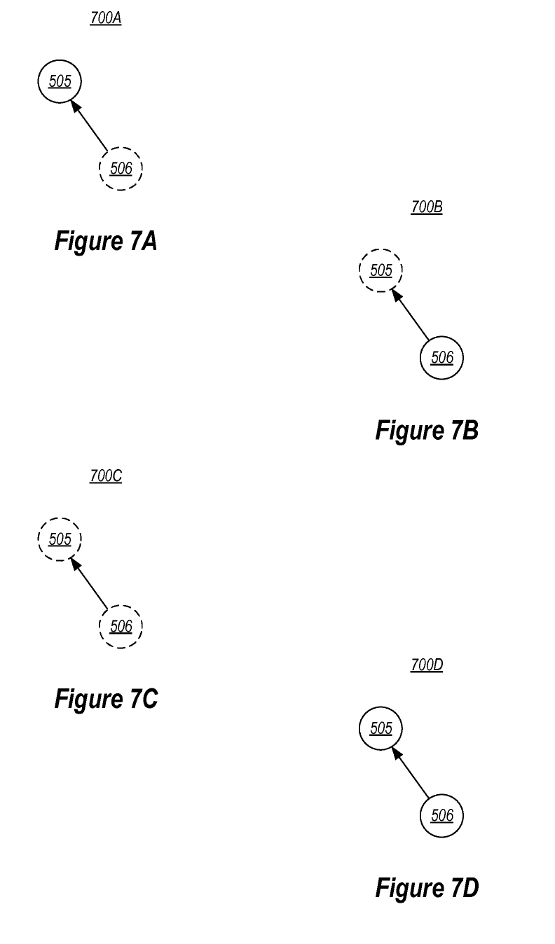

FIG. 7A through 7D illustrate several possible embodiments of how such delegation might occur from the perspective of the portion application 500B. In the symbolism of FIGS. 7A through 7D, a node represented by dashed lined borders represents a node of which only some of the endpoints of the original node are available for interfacing with the second machine and/or user.

In the embodiment 700A of FIG. 7A, the node 505 is illustrated with as a solid circle, representing that all endpoints of the node 505 have been instantiated and made available to the second machine and/or user. Meanwhile, the node 506 is illustrated with a dashed-lined circle, representing that only a portion of the endpoints of the node 506 have been instantiated and made available to the second machine and/or user.

In the embodiment 700B of FIG. 7B, the node 506 is illustrated with as a solid circle, representing that all endpoints of the node 506 have been instantiated and made available to the second machine and/or user. Meanwhile, the node 505 is illustrated with a dashed-lined circle, representing that only a portion of the endpoints of the node 505 have been instantiated and made available to the second machine and/or user.

In the embodiment 700C of FIG. 7C, the nodes 505 and 506 are both illustrated with a dashed-lined circle, representing that only a portion of the endpoints of each of the nodes 505 and 506 have been instantiated and made available to the second machine and/or user.

In the embodiment 700D of FIG. 7D, the nodes 505 and 506 are both illustrated as a solid circuit, representing that all of the endpoints of each of the nodes 505 and 506 have been instantiated and made available to the second machine and/or user.

Note that there need be no change to the instance of the application 500 that is in state 500A from the perspective of the first machine and/or user. In that case, whatever endpoints are created for nodes 505 and 506 for the second machine and/or user may simply be cloned endpoints. During operation, if a cloned input endpoint received inconsistent input from both the first machine and/or user and the second machine and/or user, merging criteria may resolve the inconsistency. For instance, perhaps inconsistencies are resolved in favor of the delegating machine and/or user.

In an alternative embodiment, a remainder instance may be created that represents a logical remainder when the portion instance 500B is subtracted from the larger instance 500A, and thus no endpoint are cloned at all. For instance, in the case of FIG. 7D, in which the second machine and/or user is given access to all endpoints of the nodes 505 and 505, a remainder instance may be created with just the nodes 501 through 504. In the case of FIG. 7A, the remainder instance might include nodes 501 through 504 and a limited form of node and 506 with only the endpoints that were not included with the node 506 of the remainder instance being included in the portion instance 700A. In the case of FIG. 7B, the remainder instance might include nodes 501 through 504, and a limited form of node 505 with only the endpoints that were not included with the node 505 of the remainder instance being included within the portion instance 700B. In the case of FIG. 7C, the remainder instance might include nodes 501 through 504, and a limited form of node 505 and 506 with only the endpoints that were not included with the nodes 505 and 506 of the remainder instance being included within the portion instance 700B.

In operation, the first machine and/or user may maintain control or supervision over the actions of the second machine and/or user in interacting with the portion 500B of the application 500A. For instance, the second machine and/or user entity may be credentialed through the first machine and/or user with respect to the portion 500B such that data flows to and from the instance of the portion application 500B are approved by and/or channeled through the remainder of the application 500A controlled by the first machine and/or user. Furthermore, the access of the second machine and/or user to data (such as a data service) is strictly controlled. Data for nodes that are not within the portion application instances are provided via the approval of the first machine and/or user.

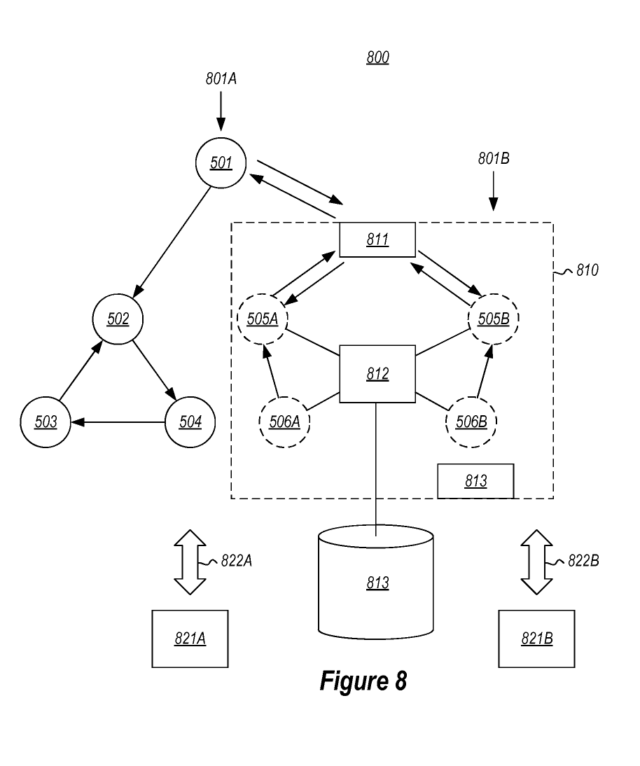

FIG. 8 illustrates an architecture 800 in which the larger application instance 801A that is assigned to a first machine and/or user 821A securely interfaces with a portion application instance 801B that is assigned to a second machine and/or user 821B via a proxy service 810.

The larger application instance 801A is similar to the application 500A of FIG. 5A, except that the first machine and/or user 821A may access only a portion of the endpoints of the node 505 (now referred to as node 505A since it now has more limited interfacing capability with the first machine and/or user 821A) and node 506 (now referred to as node 506A since it now has more limited interface capability with the first endpoint interface entity 821A). The ability of the first machine and/or user 821A to interface with the larger application instances 801A is represented by bi-directional arrow 822A.

The portion application instance 801B is similar to the portion instance 500B of FIG. 5B, except that (similar to the case of FIG. 7C) the second machine and/or user 821B may access only a portion of the endpoints of the node 505 (now referred to as node 505B since it now has more limited interfacing capability with the second machine and/or user 821B) and node 506 (now referred to as node 506B since it now has more limited interface capability with the second machine and/or user 821B). The ability of the second machine and/or user 821B to interface with the portion application instance 801B is represented by bi-directional arrow 822B.

The proxy service 810 provides a point of abstraction whereby the second machine and/or user 821B may not see or interact with the nodes 501 through 504 of the larger application instance 801A, nor may the second machine and/or user 821B interface with any of the endpoints of the nodes 505 and 506 that are assigned to the first machine and/or user 821A.

The proxy service 810 keeps track of which endpoints on node 505 are assigned to each node 505A and 505B, and which endpoints on node 506 are assigned to each node 506A and 506B. When the proxy service 810 receives input from the larger application instance (e.g., node 501), the proxy service 810 directs the processing to each of the nodes 505A and 505B as appropriate. Furthermore, when output are provided by the nodes 505A and 505B to the node 501, the proxy service 810 merges the outputs and provides the merged results to the node 501. For the perspective of the node 501, it is as though the node 501 is interacting with node 505, just as the node 501 did prior to application splitting. Accordingly, performance and function are preserved, while enabling secure application splitting, by maintaining appropriate information separation between the first and second machines and/or users 821A and 821B. Such merging of output results and splitting of inputs are performed by component 811 of the proxy service 810.

The proxy service 810 may also include a recording module 820 that evaluates inputs and outputs made to endpoints in each of the nodes 505A, 505B, 506A and 506B, and records such inputs and outputs. The recording module 812 also may record the information passed between nodes. Such recordings are made into a store 813. A replay module 813 allows the actions to be replayed. That may be particular useful if the portion application is assigned to another (i.e., a third) machine and/or user later on and a user of that third machine and/or user wants to see what was done. That third machine and/or user may come up to speed with what happened during the tenure of the second machine and/or user with the portion application.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising:
one or more processors;
one or more computer-readable storage media having thereon one or more computer-executable instructions that are structured such that, when executed by the one or more processors, configure the computing system to perform the following:
an act of recognizing when portion selection gestures have been entered onto a display;
in response to recognizing each of at least some of the portion selection gestures, an act of associating the portion selection gesture with an associated portion of a user interface displayed on the display based on spatial relation of the portion selection gesture with the associated portion, the portion of the user interface representing less than all of the user interface displayed on the display; and
in response to associating the portion selection gesture with an associated portion of the user interface, an act of causing the associated portion of the user interface be made available to a remote display that is remote from the original display.

2. The computing system in accordance with claim 1, the associated portion of the user interface being made available to the remote display by making a portion of the application that generates the associated portion of the user interface available for execution at a remote computing system associated with the remote display.

3. The computing system in accordance with claim 1, the portion of the user interface being a distinct set of one or more user interface elements.

4. The computing system in accordance with claim 1, the portion selection gesture being a positive gesture that is centered on the portion of the user interface to be shared.

5. The computing system in accordance with claim 4, the portion selection gesture being a circle gesture that substantially encloses the associated portion of the user interface.

6. The computing system in accordance with claim 1, the portion selection gesture being a negative gesture that is centered on a portion of the user interface that is not to be included in the associated portion of the user interface.

7. The computing system in accordance with claim 6, the negative gesture comprising a crossing-out gesture that intersects over the portion of the user interface that is not to be included in the associated portion of the user interface.

8. The computing system in accordance with claim 1, the portion selection gesture comprising a compound gesture comprising both a portion gesture and a negative gesture, the positive gesture being centered on the portion of the user interface to be shared, the negative gesture being centered on a portion of the user interface not to be shared.

9. The computing system in accordance with claim 8, the positive gesture being a circle gesture that substantially encloses the associated portion of the user interface.

10. The computing system in accordance with claim 9, the negative gesture comprising a crossing-out gesture that intersects over the portion of the user interface that is not to be included in the associated portion of the user interface.

11. The computing system in accordance with claim 8, the negative gesture comprising a crossing-out gesture that intersects over the portion of the user interface that is not to be included in the associated portion of the user interface.

12. The computing system in accordance with claim 1, further comprising the original display that displays the user interface.

13. The computing system in accordance with claim 1, the one or more processors being connected to a device that includes the display over a network.

14. A method for a hardware entity sharing a portion of its user interface with another hardware entity, the method comprising:
an act of recognizing when portion selection gestures have been entered onto a display;
in response to recognizing each of at least some of the portion selection gestures, an act of associating the portion selection gesture with an associated portion of a user interface displayed on the display based on spatial relation of the portion selection gesture with the associated portion, the portion of the user interface representing less than all of the user interface displayed on the display; and
in response to associating the portion selection gesture with an associated portion of the user interface, an act of causing the associated portion of the user interface be made available to a remote display that is remote from the original display.

15. The method in accordance with 14, the associated portion of the user interface being made available to the remote display by making a portion of the application that generates the associated portion of the user interface available for execution at a remote computing system associated with the remote display.

16. The method in accordance with claim 14, further comprising an act of rendering the user interface on display.

17. The method in accordance with claim 15, the portion selection gesture being a positive gesture that is centered on the portion of the user interface to be shared.

18. The method in accordance with claim 14, the portion selection gesture being a negative gesture that is centered on a portion of the user interface that is not to be included in the associated portion of the user interface.

19. A computer program product comprising one or more computer-readable storage media having thereon one or more computer-executable instructions that are structured such that, when executed by one or more processors of a computing system, cause the computing system to perform a method for a hardware entity sharing a portion of its user interface with another hardware entity, the method comprising:
an act of recognizing when portion selection gestures have been entered onto a display;
in response to recognizing each of at least some of the portion selection gestures, an act of associating the portion selection gesture with an associated portion of a user interface displayed on the display based on spatial relation of the portion selection gesture with the associated portion, the portion of the user interface representing less than all of the user interface displayed on the display; and
in response to associating the portion selection gesture with an associated portion of the user interface, an act of causing the associated portion of the user interface be made available to a remote display that is remote from the original display.

20. The computer program product in accordance with 19, the associated portion of the user interface being made available to the remote display by making a portion of the application that generates the associated portion of the user interface available for execution at a remote computing system associated with the remote display.
